(19) United States
(12) Patent Application Publication
(10) Pub. No.: US 2026/0357991 A1
(43) Pub. Date: Nov. 12, 2026

(54) COOKING APPARATUS

(71) Applicant: SAMSUNG ELECTRONICS CO., LTD., Suwon-si (KR)

(72) Inventors: Sunwoo HAN, Suwon-si (KR); Daehee KIM, Suwon-si (KR); Byounghoon MOON, Suwon-si (KR); Soonmin LIM, Suwon-si (KR); Kyunghee JUNG, Suwon-si (KR)

(73) Assignee: SAMSUNG ELECTRONICS CO., LTD., Suwon-si (KR)

(21) Appl. No.: 19/718,840

(22) Filed: Jun. 24, 2026

Related U.S. Application Data
(63) Continuation of application No. PCT/KR2024/017568, filed on Nov. 8, 2024.

(30) Foreign Application Priority Data
Jan. 5, 2024 (KR) 10-2024-0002521
Feb. 23, 2024 (KR) 10-2024-0026830

(51) Int. Cl. F24C 3/00; F24C 3/08

(52) U.S. Cl. CPC F24C 3/002; F24C 3/082

(57) ABSTRACT

A cooking apparatus including a top plate; a burner to heat a cooking container disposed on the upper plate; a manifold to allow gas to be supplied to the burner; and a manifold bracket provided to support the manifold. The manifold includes a bracket mounting portion coupleable to and decoupleable from the manifold bracket. The bracket mounting portion includes a fixing portion to which an embossing portion of the manifold bracket protruding from one surface of the manifold bracket is coupled.

### CROSS-REFERENCE TO RELATED APPLICATION

This application is a continuation application, under 35 U.S.C. § 111(a), of international application No. PCT/KR2024/017568, filed Nov. 8, 2024, which claims priority under 35 U.S. C. § 119 to Korean Patent Application No. 10-2024-0002521, filed Jan. 5, 2024 and Korean Patent Application No. 10-2024-0026830, filed Feb. 23, 2024, the disclosures of which are incorporated herein by reference in their entireties.

### TECHNICAL FIELD

The present disclosure relates to a cooking apparatus with an improved structure.

### BACKGROUND ART

Cooking apparatuses include various forms. For example, a cooking apparatus is provided as an oven range which is a combination of an oven and a gas range.

The oven range includes a cabinet-shaped main body and the oven is provided inside the main body. Also, the gas range including at least one burner is provided on the top of the main body. The gas range uses gas as an energy source for heating food.

The gas range includes a top plate on which a cooking vessel is placed, the burner that heats the cooking vessel, a manifold that supplies gas to the burner, and a valve coupled to the manifold to regulate the amount of gas discharged from the manifold.

The manifold is provided below the top plate. The manifold is fixed below the top plate by a manifold bracket.

### DISCLOSURE

### Technical Problem

An aspect of the present disclosure provides a cooking apparatus with improved assembly.

An aspect of the present disclosure provides a cooking apparatus including a manifold bracket fixable to a lower side of a manifold through an embossing portion.

The technical object intended to be achieved by the present document is not limited to the above-mentioned technical objects, and other technical objects not mentioned will be clearly understood by one of ordinary skill in the technical art to which the present disclosure belongs from the following description.

### Technical Solution

A cooking apparatus according to a concept of the present disclosure may include a top plate, a burner configured to heat a cooking vessel placed on the top plate, a manifold, configured to allow gas to be supplied to the burner, including a bracket mounting portion, and a manifold bracket, configured to support the manifold, including an embossing portion that protrudes from one surface of the manifold bracket. The manifold may include a bracket mounting portion couplable to and decoupleable from the manifold bracket. The bracket mounting portion may include a fixing portion to which an embossing portion that protrudes from one surface of the manifold bracket is coupled.

A cooking apparatus according to a concept of the present disclosure may include a top plate, a burner configured to heat a cooking vessel placed on the top plate, a manifold, configured to allow gas to be supplied to the burner and positioned below the top plate, wherein a bracket mounting portion may be provided on the manifold, and a manifold bracket couplable to and decoupleable from the bracket mounting portion to support the manifold. The manifold bracket may include a bracket body extending vertically and an embossing portion protruding from the bracket body. The bracket mounting portion may include a fixing hole into which the embossing portion is inserted.

### DESCRIPTION OF DRAWINGS

FIG. 1 shows a cooking apparatus according to an embodiment.

FIG. 2 shows a disassembled state of some components in a cooking apparatus according to an embodiment.

FIG. 3 is a side cross-sectional view taken along line A-A′ of FIG. 1 according to an embodiment.

FIG. 4 is an enlarged view of an area B denoted in FIG. 3 according to an embodiment.

FIG. 5 is a top view of a cooking apparatus according to an embodiment after a top cover is removed.

FIG. 6 shows a first manifold and surrounding components, according to an embodiment.

FIG. 7 shows the first manifold and surrounding components shown in FIG. 6 from behind according to an embodiment.

FIG. 8 shows a state in which a first manifold bracket is disassembled from the first manifold and surrounding components shown in FIG. 7 according to an embodiment.

FIG. 9 shows a state in which a first manifold bracket is disassembled from the first manifold and surrounding components shown in FIG. 7 according to an embodiment.

FIG. 10 shows a second manifold and surrounding components, according to an embodiment.

FIG. 11 shows the second manifold and surrounding components shown in FIG. 10 from behind according to an embodiment.

FIG. 12 shows a state in which a second manifold bracket is disassembled from the second manifold and surrounding components shown in FIG. 11 according to an embodiment.

FIG. 13 shows a state in which a second manifold bracket is disassembled from the second manifold and surrounding components shown in FIG. 11 according to an embodiment.

FIG. 14 shows a state in which a catching portion of a manifold bracket according to an embodiment is caught by a catching hole according to an embodiment.

FIG. 15 shows a state in which the manifold bracket shown in FIG. 14 is coupled to a bracket mounting portion by rotating according to an embodiment.

FIG. 16 shows a manifold bracket according to an embodiment, coupled to a bracket mounting portion.

FIG. 17 is a side cross-sectional view showing a state in which the manifold bracket shown in FIG. 16 is coupled to the bracket mounting portion according to an embodiment.

FIG. 18 shows a manifold bracket according to an embodiment, coupled to a bracket mounting portion.

FIG. 19 is a side cross-sectional view showing a state in which the manifold bracket shown in FIG. 18 is coupled to the bracket mounting portion according to an embodiment.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “1st”, “2nd”, or “first” or “second” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that the certain component can be connected to the other component directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a certain component is referred to as being “on” or “over” another component, it can be directly on the other component or intervening components may also be present.

As used herein, the terms “portion”, “part, ”module, or “member” may be implemented as software or hardware, and according to embodiments, a plurality of “portions”, “parts, ”modules, or “members” may be implemented as a single component, or a single “portion”, “part, ”module, or “member” may include a plurality of components.

The terms “portion”, “device”, “block”, “member”, and “module” used herein refer to a unit for processing at least one function or operation. For example, the terms may mean at least one process that may be processed by at least one hardware such as field-programmable gate array (FPGA) or application specific integrated circuit (ASIC), or at least one software or processor stored in memory.

Reference numerals used in operations are provided to identify the operations, without describing the order of the operations, and the operations can be executed in a different order from the stated order unless a specific order is definitely specified in the context.

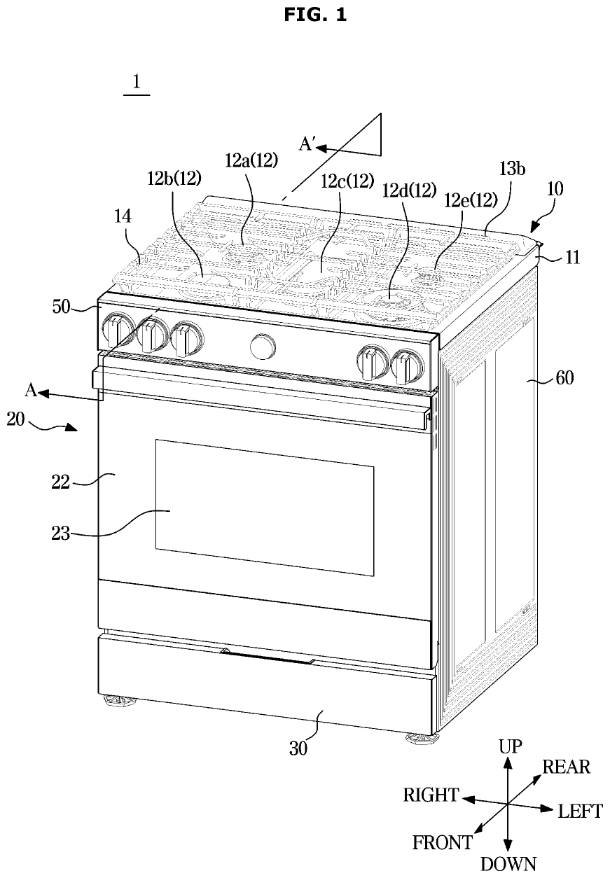

In the following description, the terms “front”, “rear”, “left”, “right”, “upper”, “lower”, etc. are defined based on the drawings, and the shapes and positions of the respective components are not limited by the terms. More specifically, as shown in FIG. 1, a direction that a door 22 of a cooking apparatus 1 faces may be defined as a front direction, and a rear direction, left and right sides, and upper and lower sides may be defined based on the front direction.

Hereinafter, embodiments of the present disclosure will be described in detail with reference to the accompanying drawings.

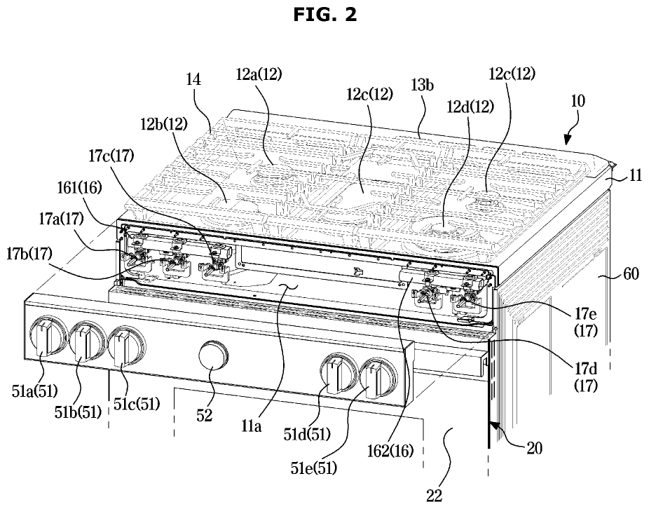

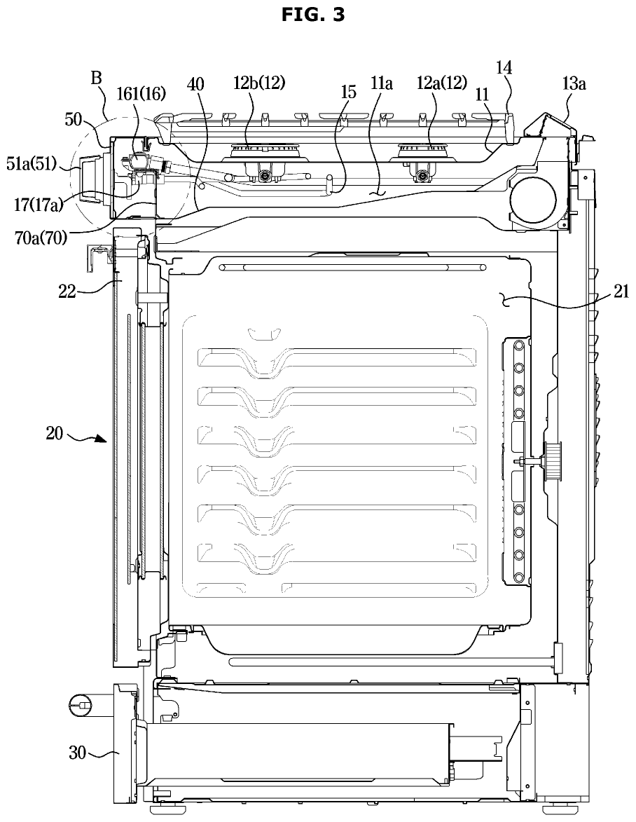

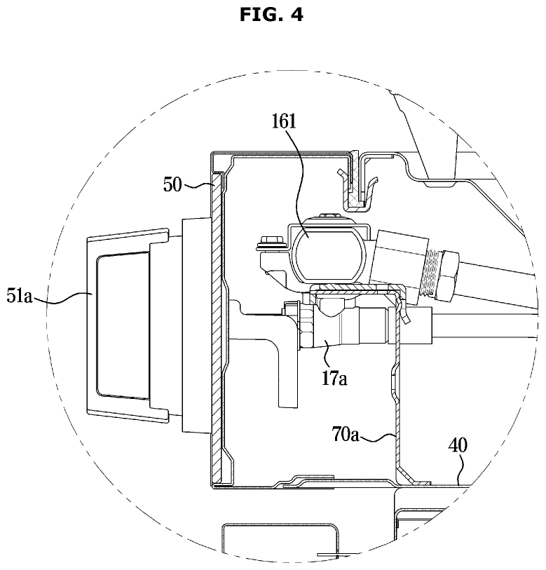

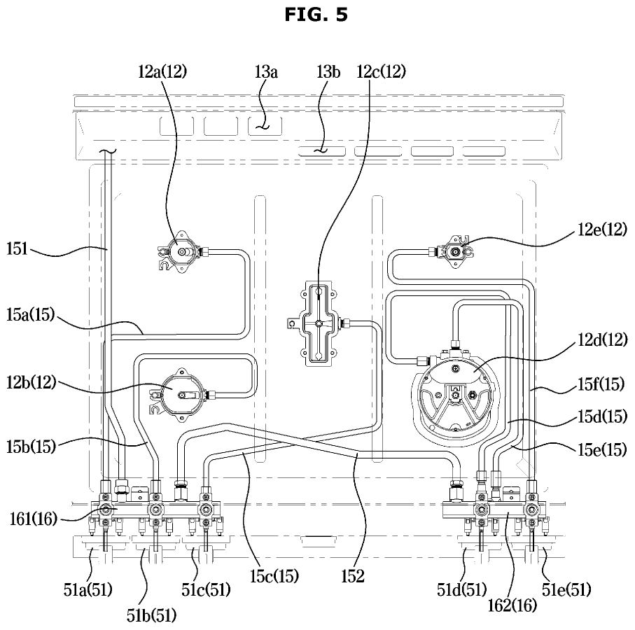

FIG. 1 shows a cooking apparatus according to an embodiment. FIG. 2 shows a disassembled state of some components in a cooking apparatus according to an embodiment. FIG. 3 is a side cross-sectional view taken along line A-A′ of FIG. 1. FIG. 4 is an enlarged view of an area B denoted in FIG. 3. FIG. 5 is a top view of a cooking apparatus according to an embodiment after a top cover is removed.

Referring to FIGS. 1 to 5, the cooking apparatus 1 may include a first cooking device 10 and a second cooking device 20. The first cooking device 10 may be positioned in an upper portion of the cooking apparatus 1, and the second cooking device 20 may be positioned in a lower portion of the cooking apparatus 1. The first cooking device 10 may be a range and the second cooking device 20 may be an oven.

In the present disclosure, the cooking apparatus 1 including both the first cooking device 10 and the second cooking device 20 is described, however, a type of the cooking apparatus 1 is not limited thereto. For example, the cooking apparatus 1 may be configured only with the first cooking device 10.

The first cooking device 10 may include a top plate 11. The top plate 11 may form an entire appearance of the first cooking device 10. A cooking vessel may be placed on the top plate 11. A cavity 11a may be provided below the top plate 11.

The first cooking device 10 may include a burner 12. The burner 12 may heat a cooking vessel placed on the top plate 11. The burner 12 may use a gas as an energy source.

A plurality of burners 12 may be provided. For example, the burners 12 may include five burners 12a, 12b, 12c, 12d, and 12e. For example, the burners 12 may include a first burner 12a, a second burner 12b, a third burner 12c, a fourth burner 12d, and a fifth burner 12e. In this case, the fourth burner 12d may be relatively larger than the other burners 12a, 12b, 12c, and 12e.

In the drawings, the five burners 12a, 12b, 12c, 12d, and 12e are shown, however, the number of the burners 12 is not limited thereto.

The first cooking device 10 may include a first opening 14a. The first opening 13a may be provided in a rear side of the top plate 11. The first opening 13a may open toward a rear direction. The first opening 13a may communicate with the cavity 11a. The first opening 13a may form a flow path together with the cavity 11a to discharge high-temperature air inside the cavity 11a.

The first cooking device 10 may include a second opening 13b. The second opening 13b may be provided in the rear side of the top plate 11. The second opening 13a may open toward the front direction. The second opening 13a may communicate with a cooking chamber 21 which will be described below. The second opening 13a may form a flow path together with the cooking chamber 21 to smoothly discharge a gas generated inside the cooking chamber 21 to outside of the cooking apparatus 1.

In the drawings, each of the first opening 13a and the second opening 13b is shown as including a plurality of openings arranged at preset intervals. However, each of the first opening 13a and the second opening 13b may be formed as a single opening.

The first cooking device 10 may include a support 14. The support 14 may be positioned on an upper side of the top plate 11. The support 14 may support a cooking vessel placed on the top plate 11.

The first cooking device 10 may include a connecting pipe 15. The connection pipe 15 may connect a valve 17 which will be described below to the burner 12. Through this configuration, a gas may be supplied from the valve 17 to the burner 12 through the connecting pipe 15.

A plurality of connecting pipes 15 may be provided. For example, the connecting pipes 15 may include a first connecting pipe 15a, a second connecting pipe 15b, a third connecting pipe 15c, a fourth connecting pipe 15d, a fifth connecting pipe 15e, and a sixth connecting pipe 15f.

For example, the first connecting pipe 15a may connect a first valve 17a which will be described below to the first burner 12a. For example, the second connecting pipe 15b may connect a second valve 17b which will be described below to the second burner 12b. For example, the third connecting pipe 15c may connect a third valve 17c which will be described below to the third burner 12c. For example, the sixth connecting pipe 15f may connect a fifth valve 17e which will be described below to the fifth burner 12e.

For example, the fourth connecting pipe 15d and the fifth connecting pipe 15e may connect a fourth valve 17d which will be described below to the fourth burner 12d. As described above, the fourth burner 12d may be relatively larger than the other burners 12a, 12b, 12c, and 12d. In this case, because both the fourth connecting pipe 15d and the fifth connecting pipe 15c supply a gas to the fourth burner 12d, the gas may be stably supplied to the fourth burner 12d having a relatively large size.

In the drawings, the six connecting pipes 15a, 15b, 15c, 15d, 15e, and 15f are shown, however, the number of the connecting pipes 15 is not limited thereto.

The first cooking device 10 may include a gas inlet pipe 151. The gas inlet pipe 151 may supply a gas from an external gas supply source to a first manifold 161 which will be described below. Details about this will be described below.

The first cooking device 10 may include a manifold connecting pipe 152. The manifold connecting pipe 152 may connect the first manifold 161 to a second manifold 162, which will be described below. Details about this will be described below.

The first cooking device 10 may include a manifold 16. The manifold 16 may be connected to the external gas supply source to receive a gas. The manifold 16 may supply the gas received from the external gas supply source to the burner 12.

The manifold 16 may be connected to the valve 17 which will be described below. That is, a gas supplied from the external gas supply source may pass through the manifold 16, the valve 17, and the connecting pipe 15 sequentially and be transferred to the burner 12.

The manifold 16 may be positioned below the top plate 11. The manifold 16 may be positioned in a front portion of the top plate 11. The manifold 16 may extend in one direction. For example, the manifold 16 may extend in a left-right direction.

The manifold 16 may include a bracket mounting portion 80. The bracket mounting portion 80 may be connected to the manifold 16. For example, the bracket mounting portion 80 may be integrated into the manifold 16. A manifold bracket 70 which will be described below may be detachably mounted on the bracket mounting portion 80. In other words, the bracket mounting portion 80 may be detachably coupled to the manifold bracket 70. Details about the bracket mounting portion 80 will be described below.

A plurality of manifolds 16 may be provided. For example, the manifolds 16 may include the first manifold 161 and the second manifold 162. The first manifold 161 may be positioned in one side of the top plate 11. The second manifold 162 may be positioned in another side of the top plate 11.

The first cooking device 10 may include the valve 17. The valve 17 may be positioned below the manifold 16. The valve 17 may connect the connecting pipe 15 to the manifold 16. The valve 17 may adjust an amount of gas that is supplied to the burner 12.

A plurality of valves 17 may be provided. The plurality of valves 17 may be arranged along one direction in which the manifold 16 extends.

The number of the valves 17 may correspond to the number of the connecting pipes 15. For example, the valves 17 may include the five valves 17a, 17b, 17c, 17d, and 17e. For example, the valves 17 may include the first valve 17a, the second valve 17b, the third valve 17c, the fourth valve 17d, and the fifth valve 17e.

In the drawings, the five valves 17a, 17b, 17c, 17d, and 17e are shown, however, the number of the valves 17 is not limited thereto.

The first cooking device 10 may include the manifold bracket 70. The manifold bracket 70 may be detachably mounted on the bracket mounting portion 80. In other words, the manifold bracket 70 may be detachably coupled to the bracket mounting portion 80. Through this configuration, the manifold bracket 70 may support the manifold 16. The manifold bracket 70 may be positioned below the manifold 16. Details about the manifold bracket 70 will be described below.

The second cooking device 20 may include the cooking chamber 21. The cooking chamber 21 may be provided in an inner space of the second cooking device 20. The cooking room 21 may form a cooking space.

The second cooking device 20 may include the door 22. The door 22 may open or close a front side of the cooking chamber 21.

The second cooking device 20 may include a window 23. The window 23 may be provided in the door 22. The window 23 may be transparent to allow a user to check a cooked state of food accommodated inside the cooking chamber 21 with his/her naked eye.

The cooking apparatus 1 may include a drawer 30. The drawer 30 may be provided in a lower portion of the second cooking device 20. The drawer 30 may be provided in a form of a drawer. More specifically, the drawer 30 may slide to be inserted into inside of the cooking apparatus 1 or pulled out from the inside of the cooking apparatus 1.

The cooking apparatus 1 may include a plate 40. The plate 40 may be positioned between the first cooking device 10 and the second cooking device 20. More specifically, the plate 40 may be positioned inside the cavity 11a. Through this configuration, the plate 40 may partition inside of the cavity 11a into an upper space of the plate 40 and a lower space of the plate 40.

The lower space of the plate 40 may communicate with the first opening 13a. The lower space of the plate 40 may communicate with an air inlet (not shown) provided in a front side of the cooking apparatus 1. That is, a flow path through which outside air flows may be formed in the lower space of the plate 40. Through this configuration, outside air with a relatively low temperature may flow into the inside of the cooking apparatus 1 to prevent overheating of the cooking apparatus 1. In addition, heat generated in the first cooking device 10 may be prevented from being transferred to the second cooking device 20 or heat generated in the second cooking device 20 may be prevented from being transferred to the first cooking device 10.

The plate 40 may include an opening (not shown). The plate 40 may form a flow path inside the cavity 11a through the opening (not shown). That is, air inside the upper space of the plate 40 may flow to the lower space of the plate 40 through the opening (not shown) of the plate 40 and then be discharged through the first opening 13a. Through this configuration, high-temperature air inside the upper space of the plate 40 may be discharged to the outside of the cooking apparatus 1.

The manifold bracket 70 may be positioned on the plate 40. That is, the manifold bracket 70 may be positioned between the manifold 16 and the plate 40. According to the manifold bracket 70 being coupled to the bracket mounting portion 80, the manifold bracket 70 may be fixed between the manifold 16 and the plate 40 and support the manifold 16.

The cooking apparatus 1 may include a control box 50. The control box 50 may be provided in a front area of the cavity 11a. The control box 50 may be detachably coupled to a front surface of the top plate 11. For example, the control box 50 may be detached from the front surface of the top plate 11 in order to repair the manifold 16 or the valve 17.

The control box 50 may include a knob 51. The knob 51 may be rotatable. The knob 51 may be connected to the valve 17. According to a degree of rotation of the knob 51, the valve 17 may adjust an amount of gas that is supplied to the burner 12.

A plurality of knobs 51 may be provided. The number of the knobs 51 may correspond to the number of the valves 17. For example, the knobs 51 may include five knobs 51a, 51b, 51c, 51d, and 51e. For example, the knobs 51 may include a first knob 51a, a second knob 51b, a third knob 51c, a fourth knob 51d, and a fifth knob 51e.

For example, the first knob 51a may be connected to the first valve 17a. For example, the second knob 51b may be connected to the second valve 17b. For example, the third knob 51c may be connected to the third valve 17c. For example, the fourth knob 51d may be connected to the fourth valve 17d. For example, the fifth knob 51e may be connected to the fifth valve 17e.

For example, the first knob 51a, the second knob 51b, and the third knob 51c may be provided on one side of the control box 50. For example, the fourth knob 51d and the fifth knob 51e may be provided on another side of the control box 50.

In the drawings, the five knobs 51a, 51b, 51c, 51d, and 51e are shown, however, the number of the knobs 51 is not limited thereto.

The control box 50 may include a controller 52. The controller 52 may control the second cooking device 20. The controller 52 may be rotatable. However, the present disclosure is not limited thereto, and the controller 52 may be provided as a button type that operates when being pressed, or as a touch screen type.

For example, the controller 52 may be provided at a center of the control box 50. For example, the controller 52 may be provided between the third knob 51c and the fourth knob 51d.

The cooking apparatus 1 may include a side cover 60. The side cover 60 may cover both sides of the second cooking device 20. The side cover 60 may support the top plate 11. Through this configuration, the top plate 11 may be spaced apart from the second cooking device 20. Also, through this configuration, the cavity 11a may be formed between the top plate 11 and the second cooking device 20.

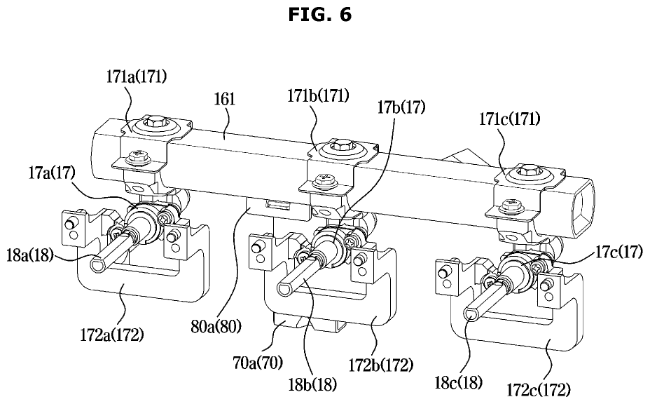

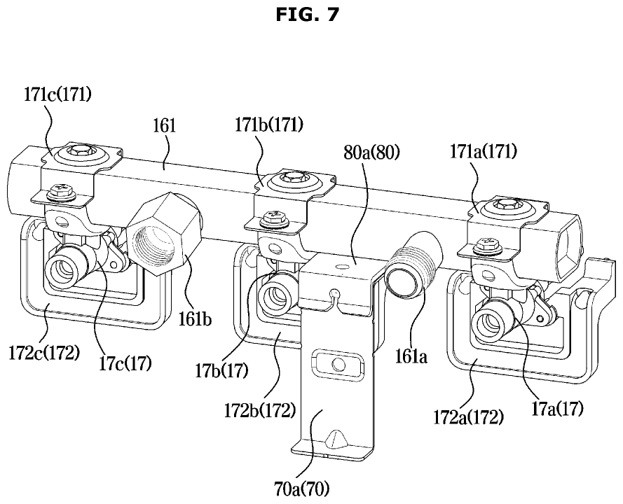

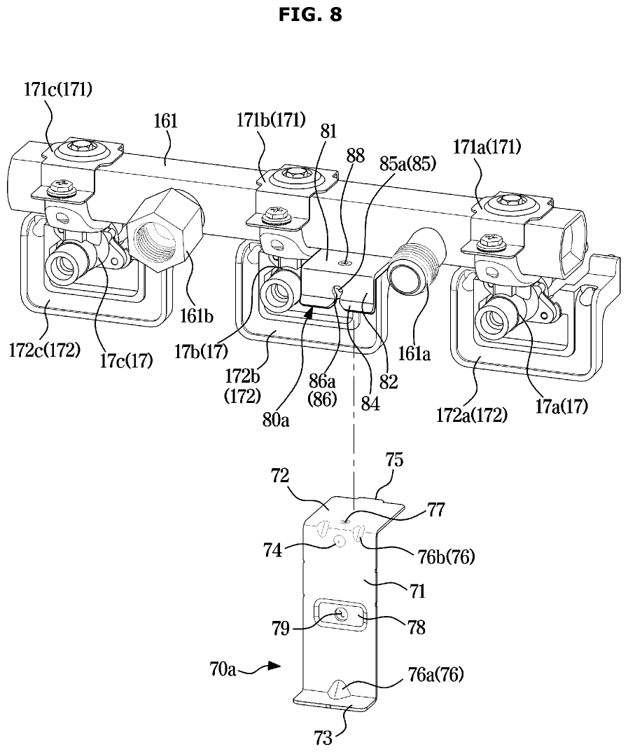

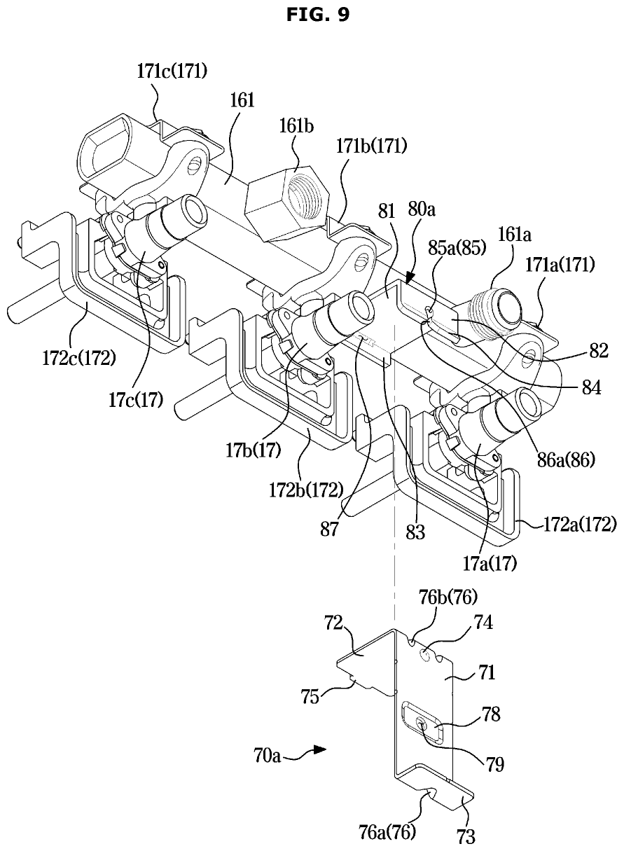

FIG. 6 shows a first manifold and surrounding components, according to an embodiment. FIG. 7 shows the first manifold and surrounding components shown in FIG. 6 from behind. FIG. 8 shows a state in which a first manifold bracket is disassembled from the first manifold and surrounding components shown in FIG. 7. FIG. 9 shows a state in which a first manifold bracket is disassembled from the first manifold and surrounding components shown in FIG. 7.

Referring to FIGS. 6 to 9, the first manifold 161 may include a gas inlet 161a. The first manifold 161 may receive a gas from the external gas supply source through the gas inlet 161a. The gas inlet 161a may be connected to the gas inlet pipe 151 connected to the external gas supply source. That is, a gas supplied from the external gas supply source may flow into the first manifold 16 through the gas inlet pipe 151 and the gas inlet 161a.

For example, the gas inlet 161a may be positioned between the first valve 17a and the second valve 17b. However, a location of the gas inlet 161a is not limited thereto.

The first manifold 161 may include a first manifold connecting portion 161b. The first manifold connecting portion 161b may be connected to one end of the manifold connecting pipe 152. Through this configuration, the first manifold 161 may supply a gas to the manifold connecting pipe 152 through the first manifold connecting portion 161b. The gas that is supplied to the manifold connecting pipe 152 may be transferred to the second manifold 162 through a second manifold connecting portion 162a, which will be described below.

For example, the first manifold connecting portion 161b may be positioned between the second valve 17b and the third valve 17c. However, a location of the first manifold connecting portion 161b is not limited thereto.

The first cooking device 10 may include a valve bracket 171. The valve bracket 171 may fix the valve 17 to a lower side of the manifold 16. For example, the valve bracket 171 may fix the valve 17 to a lower side of the first manifold 161.

A plurality of valve brackets 171 may be provided. For example, the valve brackets 171 may include a first valve bracket 171a, a second valve bracket 171b, and a third valve bracket 171c.

For example, the first valve 17a may be fixed to the lower side of the first manifold 161 through the first valve bracket 171a. For example, the second valve 17b may be fixed to the lower side of the first manifold 161 through the second valve bracket 171b. For example, the third valve 17c may be fixed to the lower side of the first manifold 161 through the third valve bracket 171c.

The first cooking device 10 may include a valve fixing portion 172. The valve fixing portion 172 may be coupled to the valve 17. The valve fixing portion 172 may be coupled to a rear surface of the control box 50 (see FIG. 2). More specifically, according to the control box 50 being coupled to the front surface of the top plate 11, the valve fixing portion 172 may be coupled to the rear surface of the control box 50 (see FIG. 2). Through this configuration, according to the control box 50 being coupled to the front surface of the top plate 11, the valve 17 and the manifold 16 may be positioned adjacent to a lower surface of the top plate 11 and fixed. In other words, when the control box 50 is separated from the top plate 11, the valve 17 may be released from the manifold 16 as long as there is neither a separate support device nor a separate fixing device, which may cause sagging. According to a concept of the present disclosure, the manifold bracket 70 may support the manifold 16 regardless of whether the control box 50 is coupled to the front surface of the top plate 11, thereby preventing sagging of the valve 17 and the manifold 16.

A plurality of valve fixing portions 172 may be provided. For example, the valve fixing portions 172 may include a first valve fixing portion 172a, a second valve fixing portion 172b, and a third valve fixing portion 172c.

For example, the first valve fixing portion 172a may be coupled to the first valve 17a. For example, the second valve fixing portion 172b may be coupled to the second valve 17b. For example, the third valve fixing portion 172c may be coupled to the third valve 17c.

The first cooking device 10 may include a knob shaft 18. The knob shaft 18 may extend from the valve 17 toward the knob 51. The knob shaft 18 may be coupled to the knob 51. That is, the valve 17 may be connected to the knob 51 through the knob shaft 18.

A plurality of knob shafts 18 may be provided. For example, the knob shafts 18 may include a first knob shaft 18a, a second knob shaft 18b, and a third knob shaft 18c.

For example, the first valve 17a may be connected to the first knob 51a through the first knob shaft 18a. For example, the second valve 17b may be connected to the second knob 51b through the second knob shaft 18b. For example, the third valve 17c may be connected to the third knob 51c through the third knob shaft 18c.

The manifold bracket 70 may include a first manifold bracket 70a. The first manifold bracket 70a may support the first manifold 161. The first manifold bracket 70a may be positioned below the first manifold 161. The first manifold bracket 70a may be positioned to correspond to a first bracket mounting portion 80a which will be described below.

The bracket mounting portion 80 may include the first bracket mounting portion 80a. The first bracket mounting portion 80a may be connected to the first manifold 161. The first bracket mounting portion 80a may be provided on the lower side of the first manifold 161. The first manifold bracket 70a may be detachably mounted on the first bracket mounting portion 80a. In other words, the first bracket mounting portion 80a may be detachably coupled to the first manifold bracket 70a. Through this configuration, the first manifold bracket 70a may support the first manifold 161.

The first bracket mounting portion 80a may be positioned between the first valve 17a and the second valve 17b. More specifically, the first bracket mounting portion 80a may be positioned between the gas inlet 161a and the second valve 17b. According to this configuration, the first manifold bracket 70a may be positioned between the gas inlet 161a and the second valve 17b. however, locations of the first bracket mounting portion 80a and the first manifold bracket 70a are not limited thereto.

A plurality of first manifold brackets 70a and a plurality of first bracket mounting portions 80a may be provided (not shown). The first manifold brackets 70a may more stably support the first manifold 161.

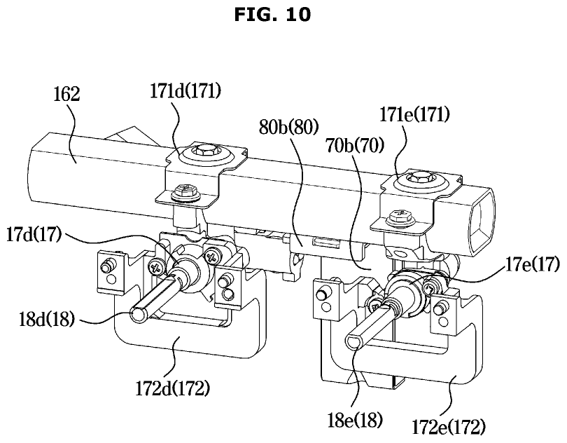

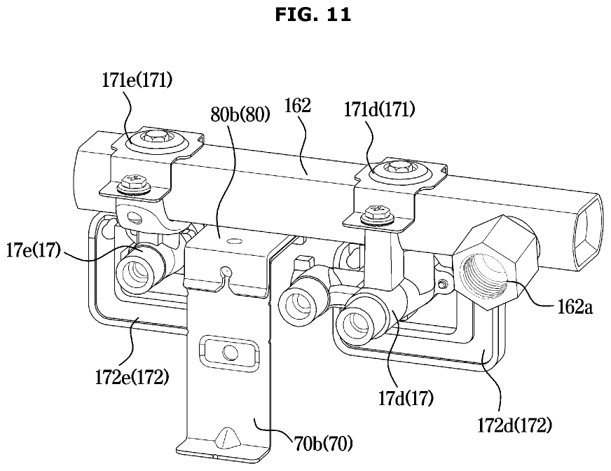

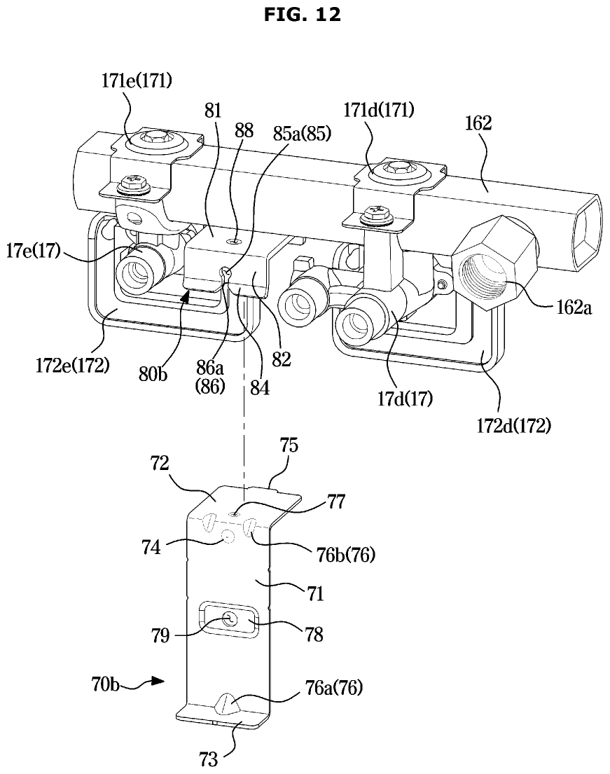

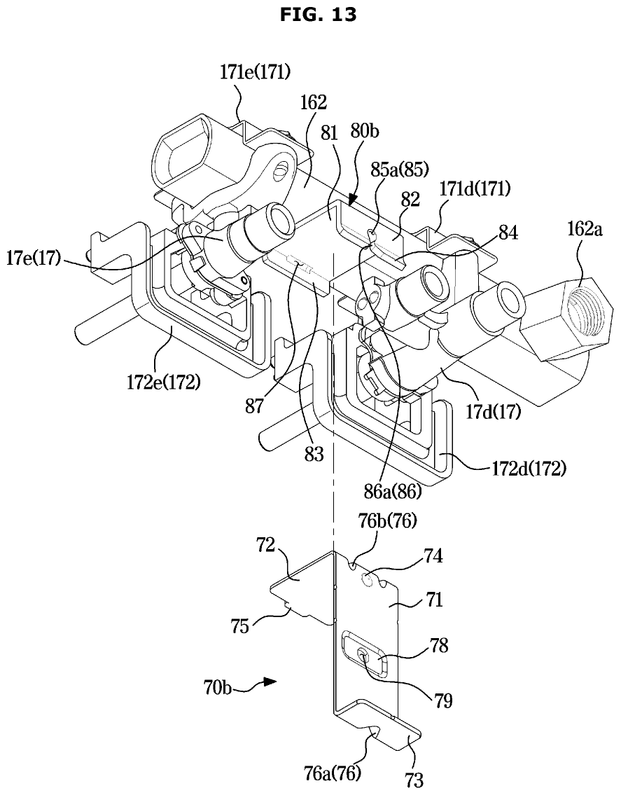

FIG. 10 shows a second manifold and surrounding components, according to an embodiment. FIG. 11 shows the second manifold and surrounding components shown in FIG. 10 from behind. FIG. 12 shows a state in which a second manifold bracket is disassembled from the first manifold and surrounding components shown in FIG. 11. FIG. 13 shows a state in which a second manifold bracket is disassembled from the second manifold and surrounding components shown in FIG. 11.

Referring to FIGS. 10 to 13, the second manifold 162 may include the second manifold connecting portion 162a. The second manifold connecting portion 162a may be connected to another end of the manifold connecting pipe 152. Through this configuration, the second manifold 162 may receive a gas from the manifold connecting pipe 152 through the second manifold connecting portion 162b. That is, a gas that is supplied from the external gas supply source may pass through the gas inlet pipe 151, the first manifold 161, and the manifold connecting pipe 152 sequentially and be transferred to the second manifold 162.

For example, the second manifold connecting portion 162a may be positioned between the fourth valve 17d and one end of the second manifold 162. However, a location of the second manifold connecting portion 162a is not limited thereto.

As described above, the first cooking device 10 may include the valve bracket 171. A plurality of valve brackets 171 may be provided. For example, the valve brackets 171 may include a fourth valve bracket 171d and a fifth valve bracket 171c.

For example, the fourth valve 17d may be fixed to a lower side of the second manifold 162 through the fourth valve bracket 171d. For example, the fifth valve 17e may be fixed to the lower side of the second manifold 162 through the fifth valve bracket 171e.

As described above, the first cooking device 10 may include the valve fixing portion 172. A plurality of valve fixing portions 172 may be provided. For example, the valve fixing portions 172 may include a fourth valve fixing portion 172d and a fifth valve fixing portion 172e.

For example, the fourth valve fixing portion 172d may be coupled to the fourth valve 17d. For example, the fifth valve fixing portion 172e may be coupled to the fifth valve 17e.

As described above, the first cooking device 10 may include the knob shaft 18. The plurality of knob shafts 18 may be provided. For example, the knob shafts 18 may include a fourth knob shaft 18d and a fifth knob shaft 18e.

For example, the fourth valve 17d may be connected to the fourth knob 51d through the fourth knob shaft 18d. For example, the fifth valve 17e may be connected to the fifth knob 51e through the fifth knob shaft 18e.

The manifold bracket 70 may include a second manifold bracket 70b. the second manifold bracket 70b may support the second manifold 162. The second manifold bracket 70b may be positioned on the lower side of the second manifold 162. The second manifold bracket 70b may be positioned to correspond to a second bracket mounting portion 80b which will be described below.

The bracket mounting portion 80 may include the second bracket mounting portion 80b. The second bracket mounting portion 80b may be connected to the second manifold 162. The second bracket mounting portion 80b may be provided on the lower side of the second manifold 162. The second manifold bracket 70b may be detachably mounted on the second bracket mounting portion 80b. In other words, the second bracket mounting portion 80b may be detachably coupled to the second manifold bracket 70b. Through this configuration, the second manifold bracket 70b may support the second manifold 162.

The second bracket mounting portion 80b may be positioned between the fourth valve 17d and the fifth valve 17e. According to this configuration, the second manifold bracket 70b may be positioned between the fourth valve 17d and the fifth valve 17e. However, locations of the second bracket mounting portion 80b and the second manifold bracket 70b are not limited thereto.

A plurality of second manifold brackets 70b and a plurality of second bracket mounting portions 80b may be provided (not shown). In this case, the second manifold brackets 70b may more stably support the second manifold 162.

Hereinafter, the manifold bracket 70 and the bracket mounting portion 80 will be described with reference to FIGS. 6 to 13. Each of the first manifold bracket 70a and the second manifold bracket 70b may include components of the manifold bracket 70, which will be described below. Each of the first bracket mounting portion 80a and the second bracket mounting portion 80b may include components of the bracket mounting portion 80, which will be described below.

The manifold bracket 70 may include a bracket body 71. The bracket body 71 may extend in one direction. For example, according to the manifold bracket 70 being coupled to the bracket mounting portion 80, the bracket body 71 may extend vertically.

The manifold bracket 70 may include a bracket head 72. The bracket head 72 may be bent from an upper end portion of the bracket body 71 and extend. More specifically, according to the manifold bracket 70 being coupled to the bracket mounting portion 80, the bracket head 72 may be bent from the upper end portion of the bracket body 71 and extend in the rear direction. In other words, according to the manifold bracket 70 being coupled to the bracket mounting portion 80, the bracket head 72 may be bent from the upper end portion of the bracket body 71 and extend in a direction away from a fixing portion 85 which will be described below.

The manifold bracket 70 may include a base 73. The base 73 may be bent from a lower end portion of the bracket body 71 and extend. More specifically, according to the manifold bracket 70 being coupled to the bracket mounting portion 80, the base 73 may be bent from the lower end portion of the bracket body 71 and extend in the front direction. In other words, according to the manifold bracket 70 being coupled to the bracket mounting portion 80, the base 73 may be bent from the lower end portion of the bracket body 71 and extend in a direction in which an embossing portion 74 which will be described below protrudes. However, an extension direction of the base 73 is not limited thereto. For example, the base 73 may extend in the rear direction or in a left or right direction.

The manifold bracket 70 may include the embossing portion 74. The embossing portion 74 may protrude from one surface of the manifold bracket 70. The embossing portion 74 may be provided on the bracket body 71.

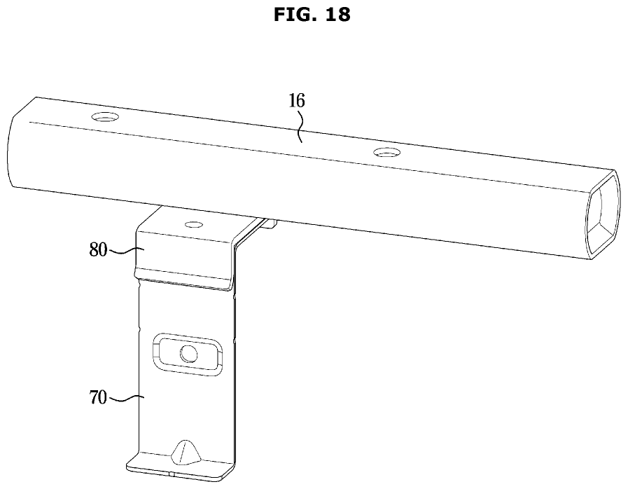

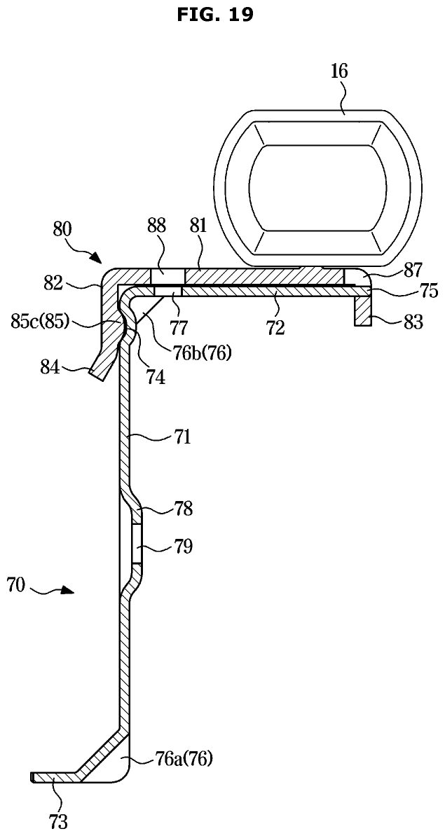

The embossing portion 74 may protrude from a front surface of the bracket body 71. More specifically, according to the manifold bracket 70 being coupled to the bracket mounting portion 80, the embossing portion 74 may protrude in the front direction from the front surface of the bracket body 71. In other words, according to the manifold bracket 70 being coupled to the bracket mounting portion 80, the embossing portion 74 may protrude from the front surface of the bracket body 71 toward the fixing portion 85 which will be described below. However, a protrusion direction of the embossing portion 74 is not limited thereto. The embossing portion 74 may protrude from a rear surface of the bracket body 71 in a direction away from the fixing portion 85 (see FIGS. 18 and 19), which will be described below.

The embossing portion 74 may have an approximately hemispherical shape. However, the shape of the embossing portion 74 is not limited thereto. For example, the embossing portion 74 may have a cuboid or an ellipsoidal shape.

The manifold bracket 70 may include a catching portion 75. The catching portion 75 may be provided at one end portion of the bracket head 72. More specifically, according to the manifold bracket 70 being coupled to the bracket mounting portion 80, the catching portion 75 may protrude in the rear direction from a rear end portion of the bracket head 72. According to the manifold bracket 70 being coupled to the bracket mounting portion 80, the catching portion 75 may be caught by a catching hole 87 which will be described below. Details about this will be described below.

The manifold bracket 70 may include a bead 76. The bead 76 may prevent the manifold bracket 70 from bending under load.

The bead 76 may include a first bead 76a. The first bead 76a may protrude between the bracket body 71 and the base 73. According to the manifold bracket 70 being coupled to the bracket mounting portion 80, the direction in which the first bead 76a protrudes may be a front direction relative to the bracket body 71. Also, according to the manifold bracket 70 being coupled to the bracket mounting portion 80, the direction in which the first bead 76a protrudes may be an upward direction relative to the base 73. A plurality of first beads 76a may be provided (not shown).

The bead 76 may include a second bead 76b. The second bead 76b may protrude between the bracket body 71 and the bracket head 72. According to the manifold bracket 70 being coupled to the bracket mounting portion 80, a direction in which the second bead 76b protrudes may be a rear direction relative to the bracket body 71. Also, according to the manifold bracket 70 being coupled to the bracket mounting portion 80, the direction in which the second bead 76b protrudes may be a downward direction relative to the bracket head 72. A plurality of second beads 76b may be provided.

The manifold bracket 70 may include a first fastening member insertion hole 77. The first fastening member insertion hole 77 may be provided in the bracket head 72. According to the manifold bracket 70 being coupled to the bracket mounting portion 80, the first fastening member insertion hole 77 may communicate with a second fastening member insertion hole 88 which will be described below. A fastening member (not shown) may be inserted into the first fastening member insertion hole 77.

The manifold bracket 70 may include a recess 78. The recess 78 may be provided in the bracket body 71. According to the manifold bracket 70 being coupled to the bracket mounting portion 80, the recess 78 may be recessed in the rear direction from the bracket body 71.

The manifold bracket 70 may include a saddle fixing hole 79. In this case, a saddle (not shown) may wrap around a plurality of wires arranged around the manifold 16. The saddle fixing hole 79 may fix the saddle (not shown). More specifically, one end of the saddle (not shown) may be inserted into and fixed to the saddle fixing hole 79. The one end of the saddle (not shown) inserted into the saddle fixing hole 79 may be rested on the recess 78.

The manifold bracket 70 may include a material having elasticity. Through this configuration, it may be easier to mount the manifold bracket 70 on the bracket mounting portion 80. Details about this will be described below.

The bracket mounting portion 80 may include a resting portion 81. The resting portion 81 may be provided in a shape of an approximately flat plate. The resting portion 81 may come into contact with the lower side of the manifold 16. A size of the resting portion 81 may correspond to that of the bracket head 72. According to the manifold bracket 70 being coupled to the bracket mounting portion 80, the bracket head 72 may be rested on the resting portion 81.

The bracket mounting portion 80 may include a first bent portion 82. The first bent portion 82 may be bent at one side of the resting portion 81 and extend downward. More specifically, the first bent portion 82 may be bent vertically at a front side of the resting portion 81 and extend downward. The first bent portion 82 may cover at least a portion of the bracket body 71. More specifically, the first bent portion 82 may cover an upper front surface of the bracket body 71.

The bracket mounting portion 80 may include a second bent portion 83. The second bent portion 82 may be bent at another side of the resting portion 81 and extend downward. More specifically, the second bent portion 82 may be bent vertically at a rear side of the resting portion 81 and extend downward.

A width of the resting portion 81 in a front-rear direction may correspond to a distance between the first bent portion 82 and the second bent portion 83. Also, according to the manifold bracket 70 being coupled to the bracket mounting portion 80, a width of the bracket head 72 in the front-rear direction may be similar to the distance between the first bent portion 82 and the second bent portion 83. Through this configuration, the bracket head 72 may be inserted between the first bent portion 82 and the second bent portion 83 in a press-fit manner. Details about this will be described below.

The bracket mounting portion 80 may include a third bent portion 84. The third bent portion 84 may be bent from a lower end of the first bent portion 82 and extend forward at an angle.

The bracket mounting portion 80 may include the fixing portion 85. The fixing portion 85 may fix the embossing portion 74. More specifically, according to the manifold bracket 70 being coupled to the bracket mounting portion 80, the fixing portion 85 may fix the embossing portion 74.

The fixing portion 85 may be provided in the first bent portion 82. More specifically, according to the manifold bracket 70 being coupled to the bracket mounting portion 80, the fixing portion 85 may be positioned to correspond to the embossing portion 74.

The fixing portion 85 may include a fixing hole 85a. The fixing hole 85a may open in the front-rear direction at the first bent portion 82.

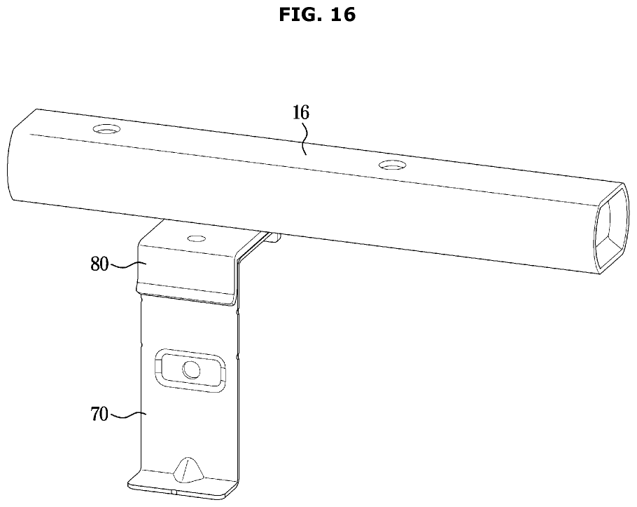

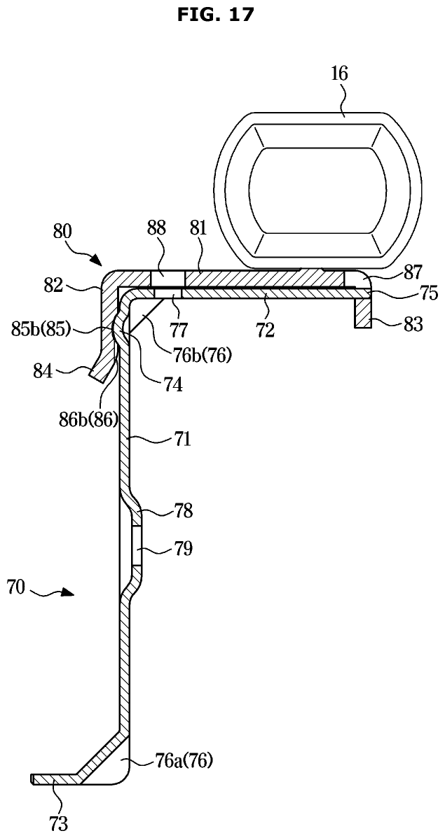

The fixing portion 85 may include a fixing groove 85b (see FIGS. 16 and 17) or a fixing projection 85c (see FIGS. 18 and 19), which will be described below. That is, the fixing portion 85 may correspond to a component for fixing the embossing portion 74 and have no restrictions in shape. Hereinafter, the fixing portion 85 will be described as including the fixing hole 85a.

The embossing portion 74 may be inserted into the fixing hole 85a. Through this configuration, according to the manifold bracket 70 being coupled to the bracket mounting portion 80, the embossing portion 74 may be inserted into the fixing hole 85a and fixed to the fixing hole 85a.

The fixing hole 85a may have a shape corresponding to that of the embossing portion 74. For example, in correspondence to the embossing portion 74 having an approximately hemispherical shape, the fixing hole 85a may have an approximately circular shape. In this case, the shape of the fixing hole 85a may refer to a shape of a cross-section of the fixing hole 85a.

The fixing hole 85a may have a width smaller than that of the embossing portion 74. For example, in the case where the embossing portion 74 has an approximately hemispherical shape and the fixing hole 85a has an approximately circular shape, a diameter of the fixing hole 85a may be smaller than that of the embossing portion 74. In other words, the diameter of the embossing portion 74 may be larger than that of the fixing hole 85a. Through this configuration, according to the manifold bracket 70 being coupled to the bracket mounting portion 80, the embossing portion 74 may be inserted into the fixing hole 85a in a press-fit manner and fixed to the fixing hole 85a.

The bracket mounting portion 80 may include a guide portion 86. The guide portion 86 may continue from the first bent portion 82 to the third bent portion 84. The guide portion 86 may extend downward from the fixing portion 85. According to the manifold bracket 70 being coupled to the bracket mounting portion 80, the guide portion 86 may guide the embossing portion 74 to the fixing portion 85.

For example, the guide portion 86 may include a first guide part 86a. The first guide part 86a may extend downward from the fixing hole 85a. The first guide part 86a may open and be connected to the fixing hole 85a. When the manifold bracket 70 is mounted on the bracket mounting portion 80, the first guide part 86a may guide the embossing portion 74 to the fixing hole 85a.

A width of an upper portion of the first guide part 86a may be smaller than the diameter of the fixing hole 85a. In other words, a portion of the first guide part 86a provided in the first bent portion 82 may have a width smaller than the diameter of the fixing hole 85a. Through this configuration, when the manifold bracket 70 is mounted on the bracket mounting portion 80, the embossing portion 74 may be guided to the fixing hole 85a while being partially inserted into the first guide part 86a, instead of being entirely inserted into the first guide part 86a.

A width of a lower portion of the first guide part 86a may increase as the first guide part 86a goes down. In other words, a width of another portion of the first guide part 86a provided in the first bent portion 82 may increase as the first guide part 86a goes down. Through this configuration, according to the manifold bracket 70 being mounted on the bracket mounting portion 80, the lower portion of the first guide part 86a may guide the embossing portion 74 to the upper portion of the first guide part 86a.

The bracket mounting portion 80 may include the catching hole 87. The catching hole 87 may be provided between the resting portion 81 and the second bent portion 83. According to the manifold bracket 70 being coupled to the bracket mounting portion 80, the catching portion 75 may be caught by the catching hole 87. According to the manifold bracket 70 being coupled to the bracket mounting portion 80, a width of the catching hole 87 in the left-right direction may have a length that is similar to a width of the catching portion 75 in the left-right direction. Through this configuration, it may be easier to mount the manifold bracket 70 on the bracket mounting portion 80. Details about this will be described below.

The bracket mounting portion 80 may include the second fastening member insertion hole 88. The second fastening member insertion hole 88 may be provided in the resting portion 81. According to the manifold bracket 70 being coupled to the bracket mounting portion 80, the second fastening member insertion hole 88 may be positioned to correspond to the first fastening member insertion hole 77. Also, according to the manifold bracket 70 being coupled to the bracket mounting portion 80, the second coupling member insertion hole 88 may communicate with the first fastening member insertion hole 77.

A fastening member (not shown) may be inserted into the second fastening member insertion hole 88. That is, a fastening member (not shown) may pass through the second fastening member insertion hole 88 and the first fastening member insertion hole 77 sequentially and be inserted into the second fastening member insertion hole 88 and the first fastening member insertion hole 77. According to the fastening member (not shown) being inserted into and fixed to the second fastening member insertion hole 88 and the first fastening member insertion hole 77, the manifold bracket 70 may be more firmly mounted on the bracket mounting portion 80.

According to a concept of the present disclosure, as a result of the manifold bracket 70 being coupled to the bracket mounting portion 80, the embossing portion 74 may protrude from the front surface of the bracket body 71 in the front direction and the catching portion 75 may protrude from the rear end portion of the bracket head 72 in the rear direction. Through this configuration, when the manifold bracket 70 is coupled to the bracket mounting portion 80, the width of the manifold bracket 70 in the front-rear direction may be larger than that of an inner side of the bracket mounting portion 80 in the front-rear direction, and the manifold bracket 70 may be more firmly mounted on the bracket mounting portion 80.

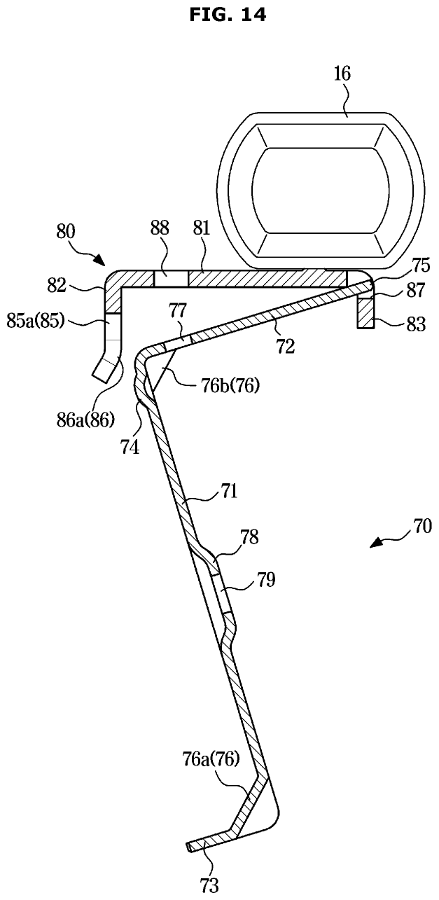

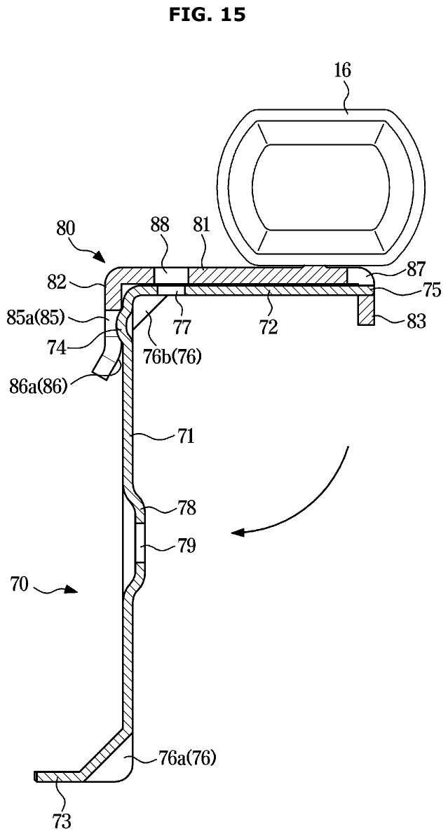

FIG. 14 shows a state in which a catching portion of a manifold bracket according to an embodiment is caught by a catching hole. FIG. 15 shows a state in which the manifold bracket shown in FIG. 14 is coupled to a bracket mounting portion by rotating.

Hereinafter, a process in which the manifold bracket 70 is mounted on the bracket mounting portion 80 will be described with reference to FIGS. 14 and 15. A process in which the first manifold bracket 70a is mounted on the first bracket mounting portion 80a may be the same as the process which will be described below. A process in which the second manifold bracket 70b is mounted on the second bracket mounting portion 80b may be the same as the process which will be described below.

Referring to FIG. 14, the catching portion 75 of the manifold bracket 70 may be inserted into and caught by the catching hole 87 of the bracket mounting portion 80. When the catching portion 75 is caught by the catching hole 87, a movement of the manifold bracket 70 in the left-right direction may be limited because the width of the catching hole 87 in the left-right direction is similar to the length of the width of the catching portion 75 in the left-right direction.

Even after the catching portion 75 is caught by the catching hole 87, the manifold bracket 70 may be rotatable. More specifically, when the catching portion 75 is caught by the catching hole 87, the manifold bracket 70 may be rotatable with respect to the catching portion 75. At this time, a rotation direction may be a clockwise direction or a counterclockwise direction in FIG. 14.

Referring to FIG. 15, the manifold bracket 70 may rotate with respect to the catching portion 75 and thus be mounted on the bracket mounting portion 80. At this time, a rotation direction of the manifold bracket 70 may be a clockwise direction in FIG. 15.

As described above, when the manifold bracket 70 is mounted on the bracket mounting portion 80, the width of the manifold bracket 70 in the front-rear direction may be larger than that of the inner side of the bracket mounting portion 80 in the front-rear direction due to the embossing portion 74 and the catching portion 75. Accordingly, while the manifold bracket 70 is mounted on the bracket mounting portion 80, elastic deformation of the manifold bracket 70 may occur due to an elastic force of the manifold bracket 70. That is, while the manifold bracket 70 is mounted on the bracket mounting portion 80, the manifold bracket 70 may be bent.

While the manifold bracket 70 is mounted on the bracket mounting portion 80, the embossing portion 74 may move upward while being in contact with the first bent portion 82. At this time, the first guide part 86a may guide the embossing portion 74 to the fixing hole 85a. Also, because the first guide part 86a opens, at least a part of the embossing portion 74 may be guided by the first guide part 86a and move while being inserted into the first guide part 86a.

While the manifold bracket 70 is mounted on the bracket mounting portion 80, the bracket head 72 may be inserted between the first bent portion 82 and the second bent portion 83 in a press-fit manner. As a result of the bracket head 72 being inserted between the first bent portion 82 and the second bent portion 83, the bracket head 72 may be rested on the resting portion 81.

According to the manifold bracket 70 being coupled to the bracket mounting portion 80, the embossing portion 74 may be inserted into the fixing hole 85a and the catching portion 75 may be inserted into the catching hole 87. Accordingly, the manifold bracket 70 may be restored from a bent state to an original state by a restoring force.

FIG. 16 shows a manifold bracket according to an embodiment, coupled to a bracket mounting portion. FIG. 17 is a side cross-sectional view showing a state in which the manifold bracket shown in FIG. 16 is coupled to the bracket mounting portion.

Hereinafter, the fixing portion 85 and the guide portion 86 according to an embodiment of the present disclosure will be described with reference to FIGS. 16 and 17. In the following descriptions about the fixing portion 85 and the guide portion 86, the substantially same components as those shown in FIGS. 1 to 15 may be assigned the same reference numerals, and detailed descriptions thereof may be omitted.

The fixing portion 85 may include the fixing groove 85b. The embossing portion 74 may be inserted into the fixing groove 85b. Through this configuration, according to the manifold bracket 70 being coupled to the bracket mounting portion 80, the embossing portion 74 may be inserted into the fixing groove 85b and fixed to the fixing groove 85b.

The fixing groove 85b may be provided in an inner side of the first bent portion 82. The fixing groove 85b may be recessed from the inner side of the first bent portion 82 toward an outer side. The fixing groove 85b may have a shape corresponding to the shape of the embossing portion 74. In correspondence to the embossing portion 74 having an approximately hemispherical shape, the fixing groove 85 may have an approximately hemispherical shape.

The fixing groove 85b may have a width smaller than that of the embossing portion 74. For example, in the case where each of the embossing portion 74 and the fixing groove 85b has an approximately hemispherical shape, a diameter of the fixing groove 85b at the entrance may be smaller than that of the embossing portion 74. In other words, the diameter of the embossing portion 74 may be larger than that of the fixing groove 85b at the entrance. Through this configuration, while the manifold bracket 70 is coupled to the bracket mounting portion 80, the embossing portion 74 may be inserted into the fixing groove 85b in a press-fit manner and fixed to the fixing groove 85b.

The guide portion 86 may include a second guide part 86b. The second guide part 86b may extend downward from the fixing groove 85b. The second guide part 86b may be connected to the fixing groove 85b. More specifically, the second guide part 86b may be recessed from the inner side of the first bent portion 82 toward the outer side and connected to the fixing groove 85b. In this case, a width of the second guide part 86b may be smaller than the diameter of the fixing groove 85b. When the manifold bracket 70 is mounted on the bracket mounting portion 80, the second guide part 86b may guide the embossing portion 74 to the fixing groove 85b.

In the drawings, only the bracket mounting portion 80 including the fixing hole 85a and the first guide part 86a and the bracket mounting portion 80 including the fixing groove 85b and the second guide part 86b are shown. However, the present disclosure is not limited thereto. For example, the bracket mounting portion 80 may include the fixing hole 85a and the second guide part 86b. For example, the bracket mounting portion 80 may include the fixing groove 85b and the first guide part 86a.

FIG. 18 shows a manifold bracket according to an embodiment, coupled to a bracket mounting portion. FIG. 19 is a side cross-sectional view showing a state in which the manifold bracket shown in FIG. 18 is coupled to the bracket mounting portion.

Hereinafter, the embossing portion 74 and the fixing portion 85 according to an embodiment of the present disclosure will be described with reference to FIGS. 18 and 19. In the following descriptions about the embossing portion 764 and the fixing portion 85, the substantially same components as those shown in FIGS. 1 to 15 may be assigned the same reference numerals, and detailed descriptions thereof may be omitted.

The embossing portion 74 may protrude from the rear surface of the bracket body 71. More specifically, according to the manifold bracket 70 being coupled to the bracket mounting portion 80, the embossing portion 74 may protrude from the rear surface of the bracket body 71 in the rear direction. In other words, according to the manifold bracket 70 being coupled to the bracket mounting portion 80, the embossing portion 74 may protrude from the rear surface of the bracket body 71 in a direction away from the fixing portion 85.

The fixing portion 85 may include the fixing projection 85c. The fixing projection 85c may protrude from the bracket mounting portion 80. The fixing projection 85c may protrude from an inner side of the first bent portion 82. More specifically, according to the manifold bracket 70 being coupled to the bracket mounting portion 80, the fixing projection 85c may protrude from the first bent portion 82 toward the embossing portion 74.

The fixing projection 85c may have a shape corresponding to that of the embossing portion 74. For example, in correspondence to the embossing portion 74 having an approximately hemispherical shape, the fixing projection 85c may have an approximately hemispherical shape. Through this configuration, according to the manifold bracket 70 being coupled to the bracket mounting portion 80, the fixing projection 85c may be inserted into the embossing portion 74. Accordingly, the manifold bracket 70 may be more firmly mounted on the bracket mounting portion 80.

A cooking apparatus 1 according to an embodiment may include a top plate 11, a burner 12 configured to heat a cooking vessel placed on the top plate 11, a manifold 16 configured to supply a gas to the burner 12, and a manifold bracket 70 configured to support the manifold 16. The manifold 16 may include a bracket mounting portion 80 detachably coupled to the manifold bracket 70, and the bracket mounting portion 80 may include a fixing portion 85 to which an embossing portion 74 protruding from one surface of the manifold bracket 70 is fixed.

According to the manifold bracket 70 being coupled to the bracket mounting portion 80, the embossing portion 74 may protrude from the one surface toward the fixing portion 85.

The fixing portion 85 may include a fixing hole 85a. According to the manifold bracket 70 being coupled to the bracket mounting portion 80, the embossing portion 74 may be inserted into the fixing hole 85a and fixed to the fixing hole 85a.

The bracket mounting portion 80 may further include a guide portion 86 configured to guide the embossing portion 74 to the fixing hole 85a when the manifold bracket 70 is mounted on the bracket mounting portion 80.

The guide portion 86 may extend downward from the fixing hole 85a.

The embossing portion 74 may have a hemispherical shape. The fixing hole 85a may have a circular shape. A diameter of the embossing portion 74 may be larger than a diameter of the fixing hole 85a.

The fixing portion 85 may include a fixing groove 85b. according to the manifold bracket 70 being coupled to the bracket mounting portion 80, the embossing portion 74 may be inserted into the fixing groove 85b and fixed to the fixing groove 85b.

According to the manifold bracket 70 being coupled to the bracket mounting portion 80, the embossing portion 74 may protrude from the one surface in a direction away from the fixing portion 85.

The fixing portion 85 may include a fixing projection 85c protruding from the bracket mounting portion 80 toward the embossing portion 74 according to the manifold bracket 70 being coupled to the bracket mounting portion 80.

The manifold 16 may include a first manifold 161 disposed in one side of the top plate 11, and a second manifold 162 disposed in another side of the top plate 11. The manifold bracket 70 may include a first manifold bracket 70a configured to support the first manifold 161, and a second manifold bracket 70b configured to support the second manifold 162.

The manifold bracket 70 may include a bracket body 71 extending vertically according to the manifold bracket 70 being coupled to the bracket mounting portion 80, and a backet head 72 bent from an upper end portion of the bracket body 71 and extending in a direction away from the fixing portion 85 according to the manifold bracket 70 being coupled to the bracket mounting portion 80.

The bracket mounting portion 80 may include a resting portion 81 on which the bracket head 72 is rested according to the manifold bracket 70 being coupled to the bracket mounting portion 80, a first bent portion 82 bent at one side of the resting portion 81, extending downward, and covering at least one portion of the bracket body 71, and a second bent portion 83 bent at another side of the resting portion 81 and extending downward.

The embossing portion 74 may be provided in the bracket body 71. The fixing portion 85 may be provided in the first bent portion 82 and disposed at a location corresponding to the embossing portion 74 according to the manifold bracket 70 being coupled to the bracket mounting portion 80.

The manifold bracket 70 may further include a catching portion 75 provided at one end portion of the bracket head 72. The bracket mounting portion 80 may further include a catching hole 87 provided between the resting portion 81 and the second bent portion 83. The catching portion 75 may be caught by the catching hole 87 according to the manifold bracket 70 being mounted on the bracket mounting portion 80.

According to the manifold bracket 70 being mounted on the bracket mounting portion 80, the bracket head 72 may be inserted between the first bent portion 82 and the second bent portion in a pressed-fit manner.

A cooking apparatus 1 according to an embodiment may include a top plate 11, a burner 12 configured to heat a cooking vessel placed on the top plate 11, a manifold 16 configured to supply a gas to the burner 12 and positioned below the top plate 11, wherein a bracket mounting portion 80 may be provided on the manifold 16, and a manifold bracket 70 detachably mounted on the bracket mounting portion 80 to support the manifold 16. The manifold bracket 70 may include a bracket body 71 extending vertically and an embossing portion 74 protruding from the bracket body 71. The bracket mounting portion 80 may include a fixing hole 85a into which the embossing portion 74 is inserted.

The embossing portion 74 may protrude from the bracket body 71 toward the fixing hole 85a.

The manifold bracket 70 may further include a bracket head 72 bent from an upper end portion of the bracket body 71 and extending in a direction away from the fixing hole 85a, and a base 73 bent from a lower end portion of the bracket body 71 and extending in a direction in which the embossing portion 74 protrudes.

The manifold bracket 70 may further include a bead protruding between the bracket body 71 and the base 73 to prevent the manifold bracket 70 from being bent.

The cooking apparatus 1 may further include a plurality of valves 17 positioned below the manifold 16 and configured to adjust an amount of gas that is supplied to the burner 12. Thee bracket mounting portion 80 may be positioned between the plurality of valves 17.

According to a concept of the present disclosure, the manifold bracket of the cooking apparatus may be more easily mounted on the bracket mounting portion through the embossing portion. Accordingly, assembly of the cooking apparatus may be improved.

According to a concept of the present disclosure, the manifold bracket of the cooking apparatus may be fixed to the lower side of the manifold through the embossing portion. That is, no separate fastening member may be required to fix the manifold bracket, and thus material costs may be reduced.

Effects that can be achieved by the present disclosure are not limited to the above-mentioned those, and other effects not mentioned may be clearly understood by one of ordinary skill in the technical art to which the present disclosure belongs from the following description.

So far, specific embodiments have been shown and described. However, the present disclosure is not limited to the above-described embodiments, and various modifications can be made by those skilled in the technical art to which the present disclosure belongs without departing from the gist of the technical idea of the disclosure defined by the claims below.

1. A cooking apparatus comprising:
a top plate;
a burner configured to heat a cooking vessel that is placed on the top plate;
a manifold, configured to allow gas to be supplied to the burner, including a bracket mounting portion; and
a manifold bracket, configured to support the manifold, including an embossing portion that protrudes from one surface of the manifold bracket,
wherein the bracket mounting portion is couplable to and decoupleable from the manifold bracket, and
the bracket mounting portion comprises a fixing portion to which the embossing portion of the manifold bracket is coupled.

2. The cooking apparatus of claim 1, wherein
while the manifold bracket is coupled to the bracket mounting portion, the embossing portion that protrudes from the one surface protrudes toward the fixing portion.

3. The cooking apparatus of claim 2, wherein
the fixing portion comprises a fixing hole, and
while the manifold bracket is coupled to the bracket mounting portion, the embossing portion is inserted into the fixing hole and fixed to the fixing hole.

4. The cooking apparatus of claim 3, wherein
the bracket mounting portion further comprises a guide portion configured to guide the embossing portion to the fixing hole based on the manifold bracket being coupled to the bracket mounting portion.

5. The cooking apparatus of claim 4, wherein
the guide portion extends downward from the fixing hole.

6. The cooking apparatus of claim 3, wherein
the embossing portion has a hemispherical shape,
the fixing hole has a circular shape, and
a diameter of the embossing portion is larger than a diameter of the fixing hole.

7. The cooking apparatus of claim 2, wherein
the fixing portion comprises a fixing groove, and
while the manifold bracket is coupled to the bracket mounting portion, the embossing portion is inserted into the fixing groove and fixed to the fixing groove.

8. The cooking apparatus of claim 1, wherein
while the manifold bracket is coupled to the bracket mounting portion, the embossing portion that protrudes from the one surface protrudes along a direction away from the fixing portion.

9. The cooking apparatus of claim 8, wherein
the fixing portion comprises a fixing projection protruding from the bracket mounting portion toward the embossing portion while the manifold bracket is coupled to the bracket mounting portion.

10. The cooking apparatus of claim 1, wherein
the manifold is a first manifold disposed in one side of the top plate and the manifold comprises:
a second manifold disposed in another side of the top plate, and
the manifold bracket is a first manifold bracket configured to support the first manifold and the manifold bracket comprises:
a second manifold bracket configured to support the second manifold.

11. The cooking apparatus of claim 1, wherein
the manifold bracket comprises:
a bracket body extending vertically while the manifold bracket is coupled to the bracket mounting portion; and
a bracket head bent from an upper end portion of the bracket body and extending in a direction away from the fixing portion while the manifold bracket is coupled to the bracket mounting portion.

12. The cooking apparatus of claim 11, wherein
the bracket mounting portion comprises:
a resting portion on which the bracket head is rested according to the manifold bracket being coupled to the bracket mounting portion;
a first bent portion bent at one side of the resting portion, extending downward, and covering at least one portion of the bracket body; and
a second bent portion bent at another side of the resting portion and extending downward.

13. The cooking apparatus of claim 12, wherein
the embossing portion is provided in the bracket body,
the fixing portion is provided in the first bent portion and disposed at a location corresponding to the embossing portion according to the manifold bracket being coupled to the bracket mounting portion.

14. The cooking apparatus of claim 12, wherein
the manifold bracket further comprises a catching portion provided at one end portion of the bracket head,
the bracket mounting portion further comprises a catching hole provided between the resting portion and the second bent portion, and
the catching portion is caught by the catching hole according to the manifold bracket being mounted on the bracket mounting portion.

15. The cooking apparatus of claim 12, wherein
while the manifold bracket is coupled to the bracket mounting portion, the bracket head is inserted between the first bent portion and the second bent portion in a pressed-fit manner.
